(19) United States
(12) Patent Application Publication
(10) Pub. No.: US 2024/0160010 A1
(43) Pub. Date: May 16, 2024

(54) RAY-BASED DESIGN AND ANALYSIS OF META LENSES

(71) Applicant: Synopsys, Inc., Mountain View, CA (US)

(72) Inventors: Bryan D. STONE, Westborough, MA (US); Yijun DING, Tucson, AZ (US)

(21) Appl. No.: 18/110,770

(22) Filed: Feb. 16, 2023

Related U.S. Application Data
(60) Provisional application No. 63/425,130, filed on Nov. 14, 2022.

(51) Int. Cl. G02B 27/00; G02B 1/00

(52) U.S. Cl. CPC G02B 27/0012; G02B 1/002

(57) ABSTRACT

The present disclosure describes systems and methods for designing a meta lens. The method includes receiving a selection of a meta atom type and determining a layout of a plurality of meta atoms of the meta atom type on a meta lens. A first dimension of each meta atom of the plurality of meta atoms is expressed as a first function of a position of the corresponding meta atom on the meta lens. The method also includes determining, based at least in part on the first function, a direction of a ray exiting the meta lens.

### CROSS-REFERENCE TO RELATED APPLICATIONS

This application claims priority to and the benefit of U.S. Provisional Patent Application Ser. No. 63/425,130, entitled “Ray-Based Analysis and Optimization of Meta Lenses,” filed Nov. 14, 2022, which is incorporated herein by reference in its entirety.

### TECHNICAL FIELD

The present disclosure relates to optical lens design, and specifically to ray-based design and analysis of meta lenses.

### BACKGROUND

Lenses are used in optical systems to focus or redirect light. Conventional lenses are formed using a smooth surface (e.g., glass or plastic). By contrast, meta lenses are formed using an arrangement of subwavelength meta atoms (which may also be referred to as pillars, nano-pillars, or nano-fins) on a surface. When light is directed across the meta lens, the meta atoms redirect and focus the light depending on the arrangement and dimensions of the meta atoms.

### SUMMARY

The present disclosure describes systems and methods for designing a meta lens. According to an embodiment, a method for designing a meta lens includes receiving a selection of a meta atom type and determining a layout of a plurality of meta atoms of the meta atom type on a meta lens. A first dimension of each meta atom of the plurality of meta atoms is expressed as a first function of a position of the corresponding meta atom on the meta lens. The method also includes determining, based at least in part on the first function, a direction of a ray exiting the meta lens.

The method may include generating a lookup table for a transfer function of the meta atom type for a set of values of the first dimension and determining, based at least in part on the lookup table, an efficiency of the ray. A second dimension of each meta atom of the plurality of meta atoms may be expressed as a second function of the position of the corresponding meta atom on the meta lens. The lookup table may indicate the transfer function of the meta atom type for a set of values of the second dimension. The direction of the ray exiting the meta lens may be based at least in part on the second function. Generating the lookup table may include determining a Jones matrix for the meta atom type for the set of values of the first dimension. The method may include determining, based at least in part on the lookup table, a polarization of the ray exiting the meta lens. The method may include updating, based at least in part on the layout, the lookup table to have a higher resolution.

The first function may include discontinuities along the meta lens. The direction of the ray exiting the meta lens may be based on positions of the discontinuities along the meta lens.

According to another embodiment, a system for designing a meta lens includes a memory and a processor communicatively coupled to the memory. The processor receives a selection of a meta atom type and determines a layout of a plurality of meta atoms of the meta atom type on a meta lens. A first dimension of each meta atom of the plurality of meta atoms is expressed as a first function of a position of the corresponding meta atom on the meta lens. The processor also determines, based at least in part on the first function, a direction of a ray exiting the meta lens.

The processor may generate a lookup table for a transfer function of the meta atom type for a set of values of the first dimension and determine, based at least in part on the lookup table, an efficiency of the ray. A second dimension of each meta atom of the plurality of meta atoms may be expressed as a second function of the position of the corresponding meta atom on the meta lens. The lookup table may indicate the transfer function of the meta atom type for a set of values of the second dimension. The direction of the ray exiting the meta lens may be based at least in part on the second function. Generating the lookup table may include determining a Jones matrix for the meta atom type for the set of values of the first dimension. The processor may determine, based at least in part on the lookup table, a polarization of the ray exiting the meta lens. The processor may update, based at least in part on the layout, the lookup table to have a higher resolution.

The first function may include discontinuities along the meta lens. The direction of the ray exiting the meta lens may be based on positions of the discontinuities along the meta lens.

According to another embodiment, a non-transitory computer readable medium stores instructions for designing a meta lens that, when executed by a processor, cause the processor to generate a lookup table for a transfer function of a meta atom type and determine a first function that expresses a first dimension of a plurality of meta atoms of the meta atom type as a function of a position of the plurality of meta atoms on a meta lens. The processor also determines, based at least in part on the lookup table and the first function, characteristics of a ray exiting the meta lens.

The characteristics may include an energy in the ray exiting the meta lens.

The processor may determine a second function that expresses a second dimension of the plurality of meta atoms as a function of the position of the plurality of meta atoms on the meta lens. The characteristics of the ray exiting the meta lens may be based at least in part on the second function.

The first function may include discontinuities along the meta lens.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1A illustrates an example meta lens.

FIG. 1B illustrates an example portion of the meta lens of FIG. 1A.

FIG. 2 illustrates an example system.

FIG. 3 illustrates an example parametrization function for a meta lens design.

FIG. 4 illustrates an example representation of a meta atom design parameter distribution for the parametrization function in FIG. 3.

FIG. 5 illustrates an example meta lens with an overlaid equivalent grating.

FIG. 6 illustrates an example ray incident on a meta lens.

FIG. 7 illustrates an example ray incident on a meta lens.

FIG. 8 illustrates an example representation of a parametrization function and meta lens design parameter distribution.

FIG. 9 is a flowchart of an example method to design and analyze a meta lens.

FIG. 10 depicts a diagram of an example computer system in which embodiments of the present disclosure may operate.

### DETAILED DESCRIPTION

Aspects of the present disclosure relate to ray-based design and analysis of meta lenses. Meta lenses are formed using an arrangement of subwavelength meta atoms (which may also be referred to as pillars) on a surface. When light is directed across the meta lens, the pillars redirect and focus the light depending on the arrangement and dimensions of the pillars.

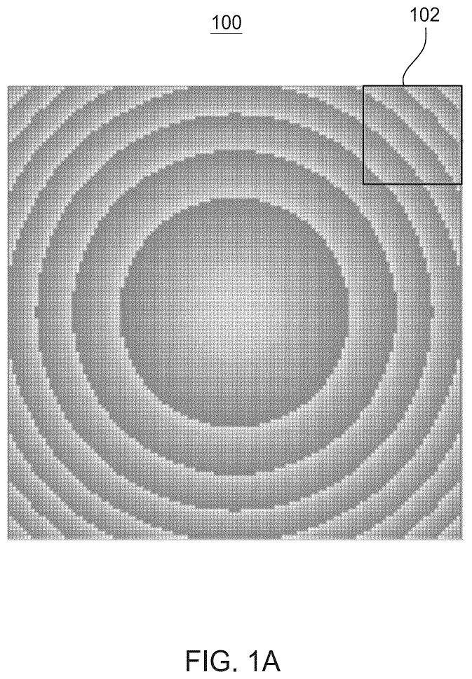

Consider an example meta lens that includes a series of cylindrical pillars of equal height but differing widths. Such a meta lens 100 is shown in FIG. 1A. A portion 102 of the meta lens 100 is shown in more detail in FIG. 1B. As seen in FIGS. 1A and 1B, the meta lens 100 includes an arrangement of pillars 104 (e.g., cylindrical pillars) on the surface of the meta lens 100. As light crosses the meta lens 100, a phase is imparted to the light by one or more of the pillars 104. The magnitude of the phase depends on the width of the pillar 104 where the light crosses the lens. By appropriate choice of the distribution of the pillar width across the surface of the meta lens 100, the meta lens 100 can focus light. The meta lens 100 can be used as a standalone single element or incorporated as one component of a subassembly that also includes other non-meta-lens optical elements.

For the light departing the meta lens 100 to be free from artifacts imparted by the discrete nature of the pillars 104, the separation between the pillars 104 may be on the order of the wavelength of light or smaller. As a result, ray-based methods for analysis and optimization have not previously been considered to be appropriate. Instead, wave-based methods that involve modeling the propagation of the electro-magnetic field are used. These wave-based methods, however, are slower and more cumbersome to use.

The present disclosure describes a ray-based system that can be used to design and analyze optical systems that incorporate one or more meta lenses. The ray-based system may be used for imaging systems or illumination systems composed solely of meta lenses, or systems that incorporate a mix of meta lenses and conventional refractive, reflective, or diffractive optical elements. Generally, the system receives a selection of a meta atom type. The system then determines functions that express parameters (e.g., width) of meta atoms of the meta atom type across a surface of a meta lens as functions of the position of the meta atoms on the surface of the meta lens. The system also generates a lookup table that provides values for a transfer function of the meta atom type for sets of values of the parameters. The system may then use the functions and the lookup table to perform ray-based design and analysis of the meta lens. For example, the system may use the functions and the lookup table to determine directions and efficiency (e.g., energy) of rays exiting the meta lens.

The system provides several technical advantages, in certain embodiments. For example, the system may implement a ray-based technique that is suitable for meta lens design and analysis. Using the lookup table may increase the speed of the ray-based analysis by avoiding the costly process of determining or calculating transfer functions on a ray-by-ray basis as the rays are being traced. Additionally, expressing meta atom parameters as functions may avoid the need to calculate the parameters for meta atoms individually. As a result, the system may allow ray-based design and analysis to become a feasible option for meta lens designers.

For many imaging applications, there is an extended object that is imaged, and this object emits (or scatters) light over a range of wavelengths. For such applications, tradeoffs may be made in the design of a meta lens to achieve the best average performance over the extended object and range of wavelengths. In the context of imaging systems that are composed of conventional refractive, reflective, or diffractive elements, ray-based tools for optimization and analysis have been developed and used successfully for countless designs.

To use such methods for the design and analysis of meta lenses, there are two pieces of information that may be used:
1. The ray directions following the meta surface. Generally, there may not be a single ray direction, but a set of discrete ray directions (or orders) that propagate in different directions akin to the different diffracted orders in a conventional grating or diffractive optical element.
2. The amount of energy (also called efficiency) that propagates in each of these orders is determined by the details of the phase that is imparted by the meta atoms in the vicinity of the ray.

The system may compute each of these two pieces of information, which may be closely linked with the expression of the meta atom parameters as functions (which may be referred to as parameterization).

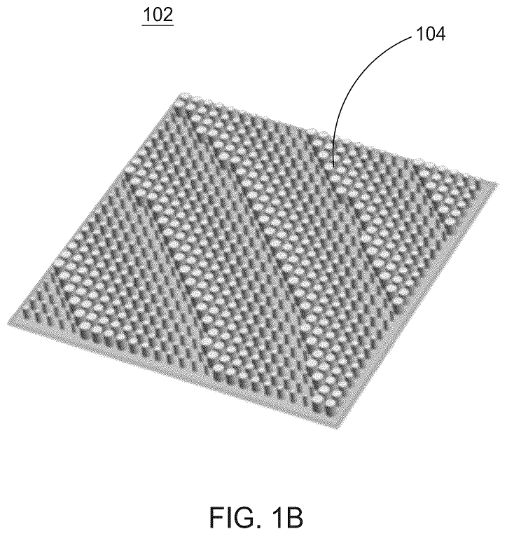

FIG. 2 illustrates an example system 200. As seen in FIG. 2, the system 200 includes one or more devices 204, a network 206, and a design device 208. Generally, the system 200 implements a ray-based technique for designing and analyzing meta lenses or optical systems that include meta lenses.

A user 202 may use the device 204 to initiate the meta lens design or analysis process. For example, the user 202 may use the device 204 to select a meta atom type or a meta lens shape. The user 202 may also use the device 204 to set limits or bounds on certain parameters (e.g., length, width, height, etc.) of the meta atoms of the meta lens. The device 204 may communicate these selections and settings to the design device 208 to initiate the meta lens design or analysis process. The device 204 is any suitable device for communicating with components of the system 200 over the network 206. As an example and not by way of limitation, the device 204 may be a computer, a laptop, a wireless or cellular telephone, an electronic notebook, a personal digital assistant, a tablet, or any other device capable of receiving, processing, storing, or communicating information with other components of the system 200. The network 206 is any suitable network operable to facilitate communication between the components of the system 200.

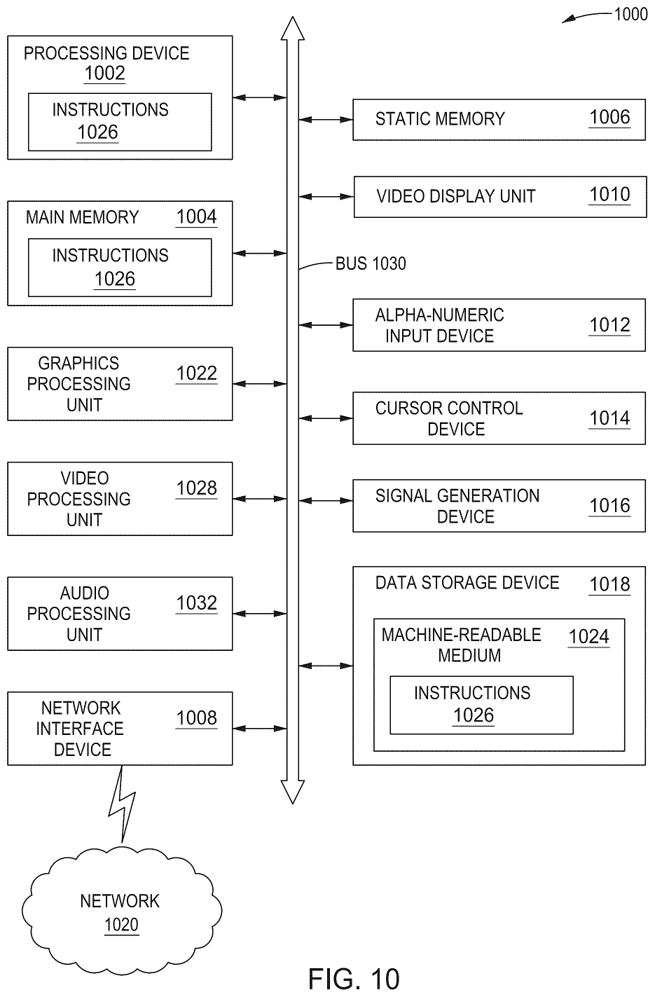

The design device 208 may be a computer system (e.g., the computer system 1000 shown in FIG. 10). The design device 208 performs the ray-based technique for designing or analyzing a meta lens. Generally, the design device 208 may be a computer system (e.g., the computer system 1000 of FIG. 10) that determines functions that express parameters (e.g., width, length, height, etc.) of meta atoms of a meta atom type as functions of positions of the meta atoms on a meta lens. The design device 208 also determines a lookup table for transfer functions of the meta atom type. The design device 208 may then perform ray-based design or analysis (e.g., determining directions of rays leaving the meta lens) using the functions and the lookup table. As seen in FIG. 2, the design device 208 includes a processor 210 and a memory 212, which may perform the actions or functions of the design device 208 described herein. The processor 210 and the memory 212 may be the processing device 1002 and the memory 1004 of the computer system 1000 shown in FIG. 10.

The design device 208 may receive a meta atom type 214 from the device 204. For example, the user may have selected the meta atom type 214 using the device 204, and the device 204 may have communicated the meta atom type 214 to the design device 208. The meta atom type 214 may indicate a certain characteristic of a meta atom. For example, the meta atom type 214 may indicate a shape (e.g., cylinder pillar, square pillar, cross-shaped pillar, etc.) of the meta atom. The selection of the meta atom type 214 may indicate a desire to use meta atoms with the selected meta atom type 214 in a meta lens.

The meta atom type 214 may include one or more parameters 216. The parameters 216 may indicate any suitable characteristic of meta atoms of the meta atom type 214. For example, the parameters 216 may indicate a size (e.g., length, width, height, radius, etc.) of the meta atoms. Rather than determining the values of the parameters 216 individually for each meta atom, the design device 208 may determine functions 218 that express the values of the parameters 216 as functions of the positions of the meta atoms on the surface of the meta lens (which may be referred to as parameterization of the parameters 216).

With the approach described in the present disclosure, the design device 208 does not control the meta atom parameter 216 for each meta atom of a meta lens individually. This would result in too many degrees of freedom and lead to inefficient and potentially unstable optimization or analysis. Instead, the meta atom parameter 216 is parametrized by a function 218 (e.g., a smooth and continuous function), and this function 218 determines the value of the meta atom parameter 216 at any point on the surface of the meta lens. For example, polynomials may be used for this parametrization, but any suitable set of functions 2118 could be used. For a rotationally symmetric meta lens, the parametrization can be taken to be solely a function of the radial position on the surface of the meta lens, but more general freeform-like parametrizations also can be used. The ray trace may use this function 218, and an optimizer may vary the function 218 or parameters 216 during the optimization or analysis.

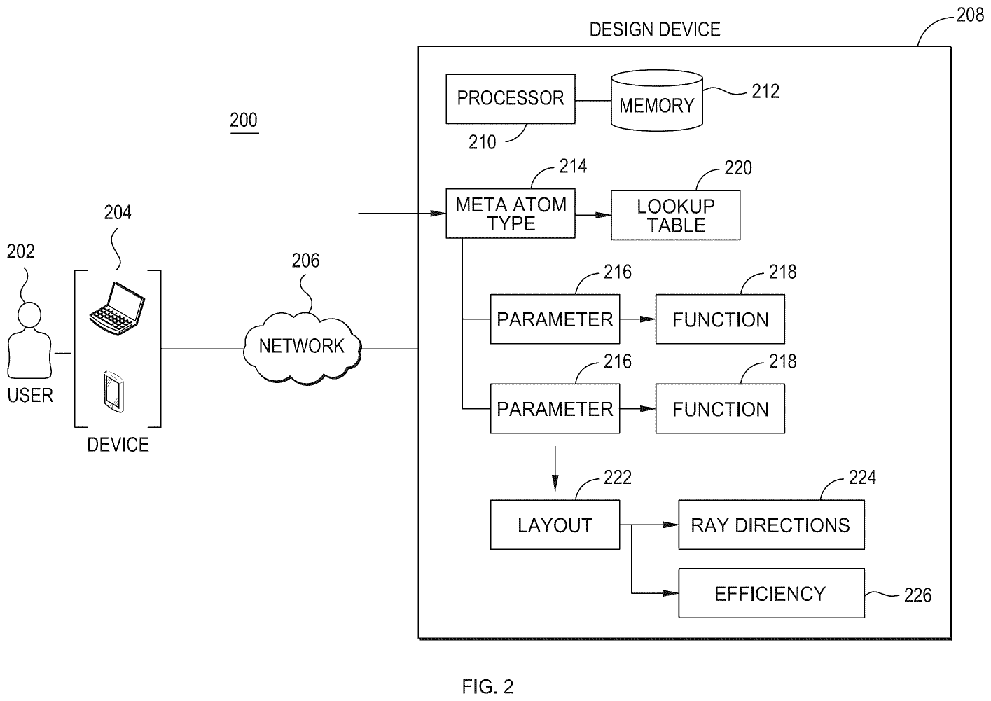

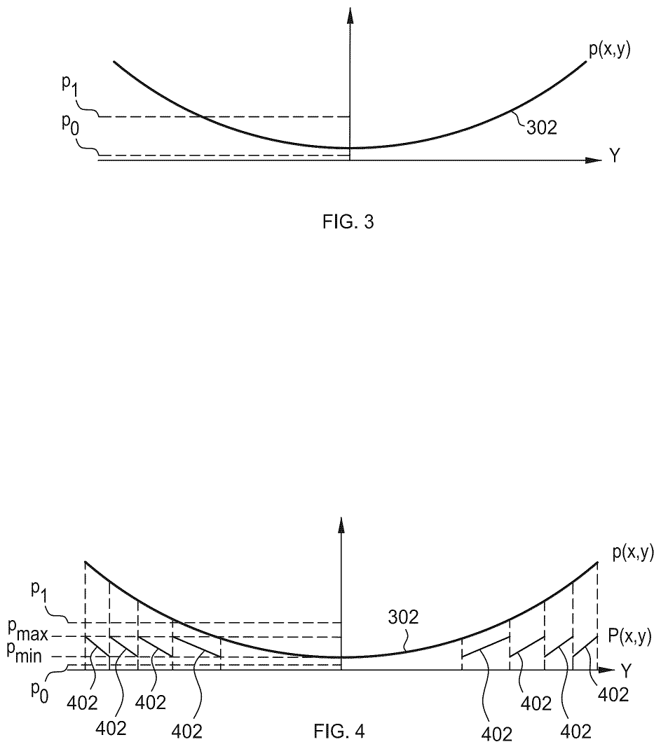

FIGS. 3 and 4 illustrate an example of parameterization. In this example, a single meta atom parameter 216 (e.g., width) is considered, but the concepts may be extended to meta atom families that are specified by more than one parameter 216.

The parametrization function 218 for the meta atom parameter 216 is referred to as p(x, y) (where x and y represent coordinates of a point on the meta lens) and is represented by the curve 302 in FIG. 3. The curve 302 shows the values of p(x, y) for a fixed x. There is typically a range of allowed values for the meta atom parameter 216. The minimum and maximum values in this range of allowed values are represented in FIG. 3 as p₀ and p₁, respectively. These values would typically come from manufacturing considerations (e.g., there is a minimum and maximum pillar diameter that can be manufactured).

For the meta lens to perform well, the design may not need to use the full range of allowed values for the parameter 216. The range of values of the parameter 216 that is actually used is denoted by pₘᵢₙ and pₘₐₓ. These values satisfy the following conditions: pₘᵢₙ>p₀; pₘₐₓ<p₁; and pₘᵢₙ<pₘₐₓ. Stated differently, and as seen in FIG. 4, both pₘᵢₙ and pₘₐₓ may be between p₀ and p₁. The meta atom parameter 216 itself as a function of position on the meta lens [referred to as P(x, y)] is then taken to be given by

P(x,y)=pₘᵢₙ+mod{[p(x,y)−pₘᵢₙ],(pₘₐₓ−pₘᵢₙ)} (1)

where mod is the modulo operator. Given a parametrization, p(x, y), as shown by the curve 302 in FIG. 4, and values of pₘᵢₙ and pₘₐₓ as shown, the resulting distribution of the meta atom parameter 216, P(x, y), is represented by a discontinuous curve 402 with values between pₘᵢₙ and pₘₐₓ. The curve 402 shows the values of P(x, y) with a fixed x. The value of P(x, y) varies across the surface of the meta lens.

To understand how ray tracing may be used effectively to analyze and optimize a system that incorporates meta lenses, it may be noted that the curve 402 in FIG. 4 resembles a conventional diffractive optical element. As such, the function

[p(x,y)−pₘᵢₙ]/(pₘₐₓ−pₘᵢₙ) (2)

may be analogous to the phase function that is conventionally used to specify conventional diffractive optical elements. It follows that standard techniques for raytracing diffractive elements may be applied to such meta lenses.

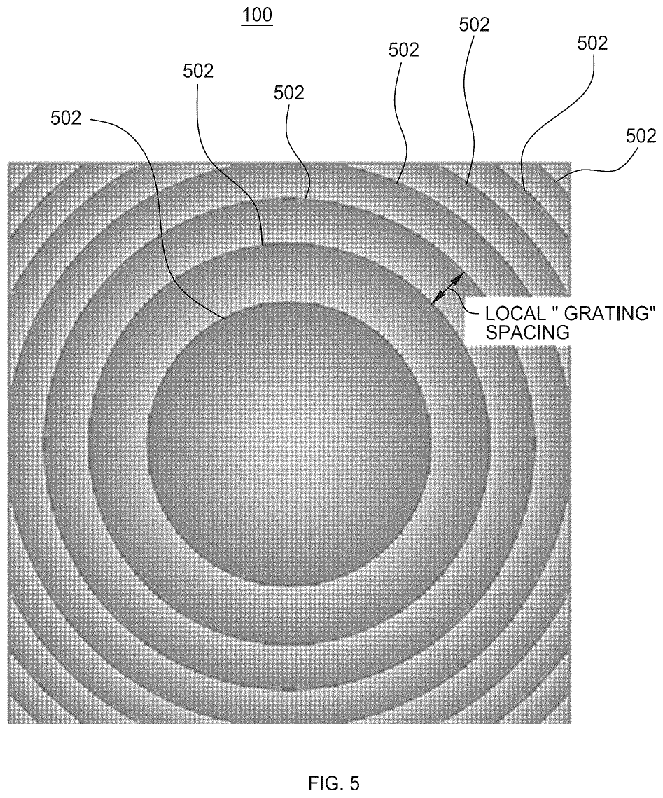

Stated differently, the meta atom distribution across the meta lens—and in particular the discontinuities in the meta atom parameter 216—behaves like a diffraction grating. The grating-like nature of the meta lens 100 that is shown in FIG. 1A is made explicit in FIG. 5, where the circles 502 are drawn at the locations of the discontinuities of the pillar widths. These circles 502 then determine a local equivalent grating spacing, which may be the radial di stance between the circles 502.

Light incident on a grating can couple into multiple orders. Typically, there will be one order (call it the design order) that is of primary interest. Orders other than the design order can also be analyzed to determine where the light from these other orders will fall on the image or target surface (such light is generally considered stray light). Once the ray directions into the different orders are known, the efficiency (or amount of energy) associated with each order may be determined.

The grating structure may not always be as clear as it is for the case of a pillar width shown in FIG. 5. In that figure, the discontinuous changes in the pillar width from narrow to wide are clearly seen. If the pillars were rectangular and the pillar parameter is the rotation angle of the rectangular pillar (so that p₀=0 and p₁=π), then the grating structure would be harder to discern from a figure analogous to that shown in FIG. 5. The methods described in the present disclosure work equally well for such a meta atom family or type.

Returning to FIG. 2, the design device 208 may determine or generate a lookup table 220 for a transfer function of the meta atom type 214. Generally, by determining or generating the lookup table 220, the design device 208 precomputes the transfer function for the meta atom type 214. The values in the lookup table 220 may then be referenced or used during ray tracing to improve the speed of the ray tracing process, in certain embodiments.

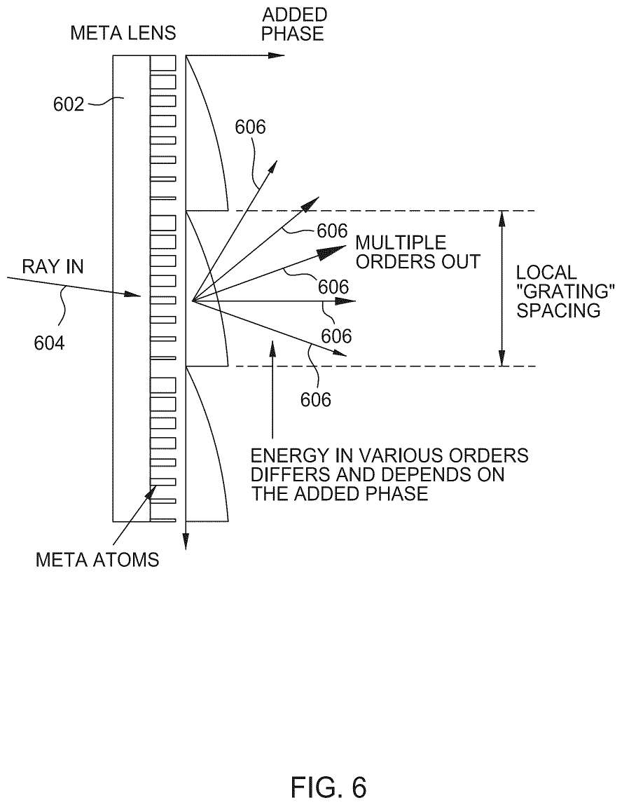

When determining the ray directions for the various orders, the parametrization of the meta atom parameters 216 may be used and no information about the phase that is imparted by the pillars may be needed, because the ray directions from a diffraction grating may depend only on the grating spacing and not the details of the phase change that occurs within one period. To know how the energy of an incident ray is distributed among the various orders, however, the details of the phase change that occurs within one period may be needed. As illustrated schematically in FIG. 6, the meta lens 602 may impart one or more phases to a ray 604 incident on the meta lens 602. The added phase due to the meta lens 602 may need to be known before one can determine the energy in the various orders 606 exiting the meta lens 602.

The meta lens 602 generally does not transmit all incident light—the sum of the energy in all of the orders 606 does not generally sum to the energy of the incident ray 604. The amount of light lost (either from absorption or reflection for a transmissive meta lens 602, or from absorption and transmission for a reflective meta lens 602) may also be needed at this stage. The added phase and the light lost together make up what is referred to as the transfer function for the meta lens 602.

The transfer function is generally a function of the input ray 604 direction (angle of incidence), wavelength, and, in some cases, polarization. This is in addition to also being a function of the meta-atom parameters 216. Various methods can be used to determine this added phase such as finite-difference time domain (FDTD) or rigorous couple-wave analysis (RCWA).

Although the transfer function can be computed on a ray-by-ray basis as the rays are being traced, the computation of the transfer function can be costly and such an approach would unacceptably slow the ray trace. The design device 208 precomputes the transfer function (as a function of all relevant parameters—angle of incidence, wavelength, polarization, and meta-atom parameters 216) for discrete sets of values of these parameters. The precomputed data for the transfer function is stored in the lookup table 220. During ray tracing, when a ray is incident on the meta lens, the value for the transfer function may be interpolated from the values in the lookup table 220. The algorithm to perform the interpolation may also be included in the lookup table 220. The amount of time it takes to compute the transfer function over a relevant range of incident ray directions, wavelengths, polarization, and meta atom parameters 216 may be large, but using the lookup table 220 may be very fast.

This approach does allow the design device 208 to start with relatively coarse grids in the sampling of the various parameters included in the lookup table 220, and then to go to finer grids as the design progresses and the range of values of parameters (like incident ray direction) are better understood for the particular design.

The user 202 selects the meta atom type 214 to use in a design, and the design device 208 precomputes the transfer function for that meta atom type 214. For example, the meta atom type 214 may be cylindrical pillars of equal height but differing widths. The design device 208 may compute the transfer function as a function of incident ray direction, wavelength, polarization, and pillar width for this meta atom type 214. The data for the transfer function may be included in the lookup table 220 for the meta atom type 214. If the user 202 decides to use a different meta atom type 214 (e.g., rectangular pillars), the design device 208 would compute a lookup table 220 for this meta atom type 214 (as a function of length and width of the pillar as well as the incident ray direction, wavelength, and polarization).

Not all of the parameters that the transfer function may depend on may be built into the lookup table 220. For example, if a system is only going to operate at one wavelength, then the transfer function may be computed only for that one wavelength. Likewise, if a particular meta atom type 214 does not alter the polarization state of the incident light, then the lookup table 220 for the transfer function need not include polarization.

After the lookup table 220 has been precomputed, Fourier optics may be used together with the functional form of the parametrization of the pillars to estimate the amount of energy (or efficiency) that goes into the various orders. The design device 208 may model the meta lens as a comb function convolved with one period of the transfer function. The far-field that results from sending a plane wave through this structure is then the product of a different comb function in Fourier space and the Fourier transform of one period of the transfer function.

As discussed above, the function for the parametrization, [p(x, y)−pₘᵢₙ]/(pₘₐₓ−pₘᵢₙ), is taken to be a stand-in for the phase function used in the ray trace for conventional diffractives. As such, (∂p/∂x, ∂p/∂y)/(pₘₐₓ−pₘᵢₙ) may be the local grating vector (its magnitude is the local grating frequency, which equals one divided by the local grating period). In the following discussion, the coordinate system is taken (without loss of generality) to be chosen such that the Y-axis is parallel to the local grating vector (so that in this coordinate system ∂p/∂x=0). In what follows, the local gating period is denoted by D.

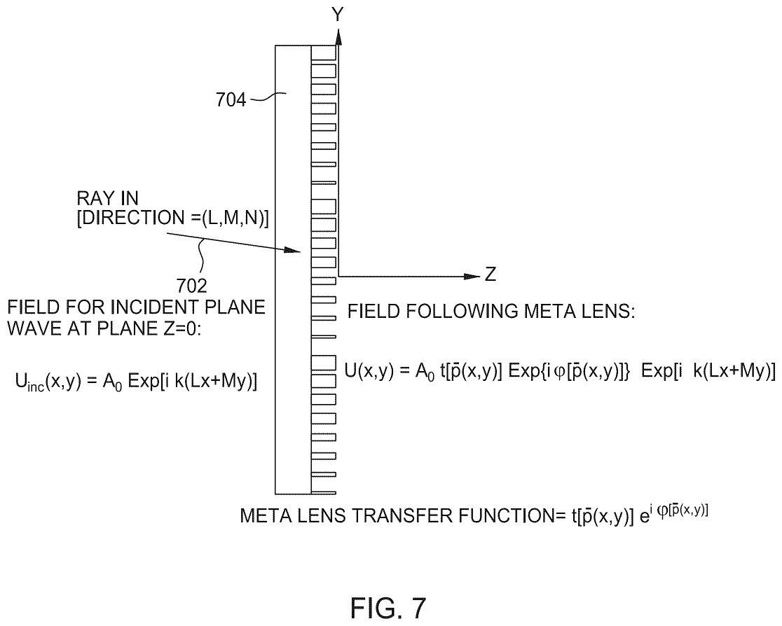

Consider a ray 702 incident on the meta lens 704 as shown in FIG. 7. In FIG. 7, the field (U) following the meta lens 704 may equal the product of the incident field and the meta lens transfer function. t[p̅(x, y)] is the amplitude transmittance of the meta lens as a function of the meta atom parameters 216, and φ[p̅(x, y)] is the added phase—also as a function of the meta atom parameters 216, where p̅(x, y):=[p(x, y) pₘᵢₙ]/(pₘₐₓ−pₘᵢₙ). Both t[p̅(x, y)] and φ[p̅(x, y)] may be determined from the precomputed lookup table 220 for the meta atom type 214 being considered.

Take the incident field to be a plane wave with amplitude A₀ propagating with optical direction cosines of (L, M, N). The field, U(x, y), following the meta lens 704 is then given by

U(x,y)=A₀t[p̅(x,y)]Exp{iφ[p̅(x,y)]}Exp[ik(Lx+My)], (3)

where k=2π/λ (and λ is the wavelength of the light) and A₀ is the complex amplitude.

One procedure for computing diffraction efficiency is to treat the incident ray 702 as an infinite plane-wave propagating in the direction of the ray 702 and the grating as an infinite linear grating whose parameters follow from the local grating at the point where the ray 702 is incident. As such, the far-field after the meta lens 704 follows from standard Fourier optics.

U(L′,M′)=A₀δ(L,L′)∫_{-∞}^{∞}comb(y/D)*(t[p̅(x,y)]Exp{iφ[p̅(x,y)]}Exp[ik(M−M′)y])dy (4)

The form of the integral is that of a Fourier transform, where the transform variable is (M−M′)/λ. Applying the convolution theorem results in the following:

$$U ( {L}^{′} , {M}^{′} ) = {A}_{0} δ ( L , {L}^{′} ) comb [ \frac{( M - {M}^{′} ) D}{λ} ] \times ( \frac{1}{D} {\int }_{0}^{D} t [ \overline{p} ( x , y ) ] Exp \{ i φ [ \overline{p} ( x , y ) ] \} Exp [ ik ( M - {M}^{′} ) y ] dy ) \qquad ( 5 )$$

where L′ and M′ are the far-field directions, and δ is the Kronecker delta function (the term δ(L, L′) indicates that the X-direction cosine of the ray is unchanged by a grating whose grating vector is in the Y-direction). In the above expression, comb [(M−M′)D/λ] gives the directions of the various orders: M′=M−m λ/D, where m is the order. The efficiency in any given order then follows from magnitude squared of the term in parentheses evaluated at the direction for that order.

This can be taken a step further for meta atoms where the phase (φ) is roughly linear in the meta atom parameter 216. It may not be precisely so—but at the very least it may be monotonic. In such cases, an approach similar to that for blazed gratings can be taken, where a linear approximation for the phase is used in the integral for the diffraction efficiency (called DE in the below equation):

$$DE = {\vert {e}^{i {φ}_{0}} \frac{{t}_{0}}{D} {\int }_{0}^{D} Exp ( i \frac{\partial φ}{\partial \overline{p}} \frac{\partial \overline{p}}{\partial y} y ) Exp [ ik ( M - {M}^{′} ) y ] dy \vert}^{2} \qquad ( 6 )$$

In the above equation, to is the value of the meta atom transmission evaluated for the ray being traced {e.g., t[p̅(x, y)]}.

Evaluating the integral, noting that ∂φ/∂p̅=1/D, setting M′=M−m λ/D, and simplifying slightly gives:

$$DE = \frac{{t}_{0}^{2} {sin}^{2} ( \frac{1 \partial φ}{2 \partial \overline{p}} + m π )}{{( \frac{1 \partial φ}{2 \partial \overline{p}} + m π )}^{2}} \qquad ( 7 )$$

The above expression for diffraction efficiency into order m may be computed provided that the lookup table 220 contains not just phase as a function of the meta-atom parameter [φ[p̅(x, y)], but also the derivative of this phase (finite differences may be used if the phase derivative of the phase is not available directly in the lookup table 220). Although it was not made explicit in the equation for DE, the phase may also depend on the wavelength, incident ray direction, etc., and the value of the derivative appropriate for the wavelength, direction, and polarization state of the ray being traced may be chosen.

Taking the transmission to be constant may be reasonable as amplitude variations affect the efficiency less strongly than phase variations. If this approximation turns out not to work well for a given application, the integral given by Eq. (5) can be evaluated numerically with the full form of t[p̅(x, y)]. It is also possible to develop an analog of Eq. (7) when the first-order term is also included in the t[p̅(x, y)] (as opposed to just the constant term). By including the transmittance of the meta atoms in the analysis [even if just the simple approximation used in Eq. (7)], it allows an optimizer to effectively balance diffraction efficiency against transmittance of the meta atoms. For example, if the values of pₘᵢₙ and pₘₐₓ that give the highest efficiency incur significant transmission losses from the meta atoms, but differing values of pₘᵢₙ and pₘₐₓ have lower efficiency but less transmission loss, then the optimizer may strike a balance between the efficiency and transmission loss that achieves maximum energy throughput.

Returning to FIG. 2, the design device 208 may determine a layout 222 for a meta lens using the functions 218. The meta atoms in the layout 222 may be of the selected meta atom type 214. The parameters 216 (e.g., width) of the meta atoms in the layout may have values determined according to the functions 218. The design device 208 may then use ray tracing to analyze the meta lens. For example, the design device 208 may determine one or more ray directions 224 exiting the meta lens using the functions 218. The design device 208 may also determine the efficiencies 226 of one or more orders of the ray existing the meta lens using the information in the lookup table 220. In this manner, the design device 208 may quickly evaluate how the rays exiting the meta lens will travel (e.g., if the meta lens focuses the rays as desired).

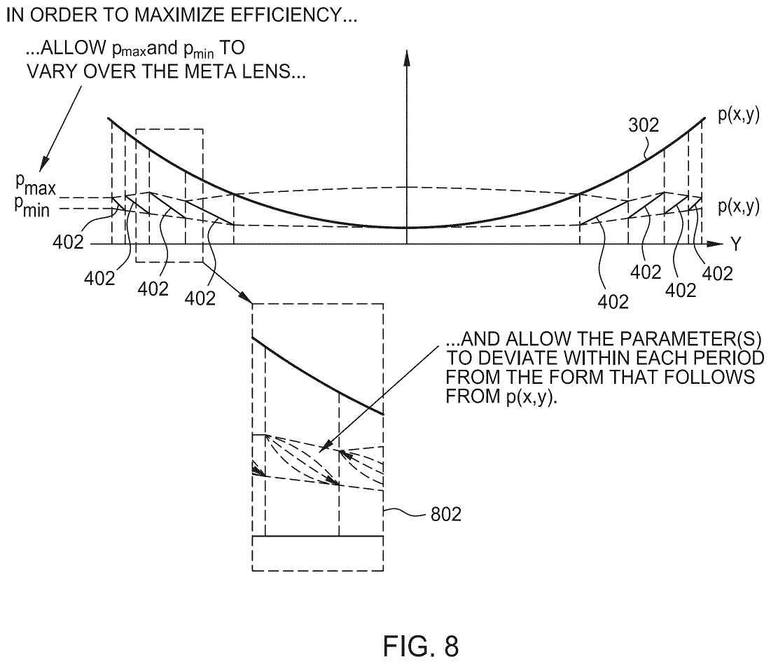

As explained above, the ray direction 224 may depend solely on the locations of the discontinuities in the meta atom parameter; the details of how the phase varies across each zone may determine the efficiency 226. As such, it is possible to tailor the value of a meta atom parameter 216 within each zone to achieve maximum efficiency 226. This can include both (i) allowing the values of pₘᵢₙ and pₘₐₓ to not be fixed for the lens but to vary across the lens, and (ii) allowing the meta atom parameter 216 connecting pₘᵢₙ to pₘₐₓ to not precisely adhere to the curve that follows from p(x, y), but to deviate from that curve. These two options for further tailoring efficiency 226 are illustrated schematically in FIG. 8. The curve 302 for p(x, y) and the curve 402 for P(x, y) are shown in FIG. 8. Additionally, pₘᵢₙ and pₘₐₓ vary across the lens. In a portion 802 of the curve 402, the value of P(x, y) may vary or deviate from the form of the curve 302. One other possibility (not shown in FIG. 8) is to allow the desired design order not to be fixed across the part. For example, in the center of the part the first order can be chosen, but towards the edges this can switch to use the second order.

When more than one parameter 216 is used to describe a meta atom type 214 of interest, the methods described herein for one parameter 216 meta atoms may be applied with slight modifications. For example, a family of rectangular meta atoms may have meta atom parameters 216 of the length and width of the rectangle. There may be two functions 218 needed to parametrize the meta atoms—p₁(x, y) and p₂(x, y). It follows that the length and width of the meta atom at location (x, y) on the surface will be given by

Length(x,y)=p_{1,min}+mod{[p₁(x,y(−p_{1,min}],(p_{1,max}−p_{1,min})}

Width(x,y)=p_{2,min}+mod{[p₂(x,y)−p_{2,min}],(p_{2,max}−p_{2,min})}

In this case, the meta lens still behaves very much like a grating, but now the grating structure comes from the locations where either meta atom parameter (e.g., either Length or Width) has a discontinuity.

As mentioned previously, when the meta atoms alter the polarization state of the light, the lookup table 220 may include not just a single added phase, but also the Jones matrix imparted by the meta atoms [as functions of wavelength, incident ray direction, and meta-atom parameters 216]. When a ray is incident on the meta lens, the lookup table 220 would then be used to determine the Jones matrix that should be applied to the ray and the ray trace code would need to apply this Jones matrix.

The design device 208 may provide the following features:
Parametrizing the meta atom structure to allow evaluation and analysis to take place with relatively few parameters to specify the meta-lens rather than dealing directly with the individual meta-atoms and using the modulo function to model discontinuities in the meta lens parameter 216. This can greatly reduce the number of degrees of freedom.

Treating the macro structure of the meta-lens analogously to a diffractive for the purposes of ray tracing so that rays can be used for evaluation and analysis.
Allow pₘᵢₙ, pₘₐₓ, and the meta-atom parameters to vary within each grating period to maximize efficiency (e.g., send as much light into the desired order as possible).
Ability to start with a low-resolution lookup table 220 that can be constructed more quickly and then increase resolution once a roughed-in design is achieved. A higher-resolution lookup table 220 could be constructed for the values of the design parameters that are being used for the roughed-in design.

In an example operation, the design device 208 may design a meta lens using the ray-based approach. The user 202 may first choose a meta atom type 214 to be used in the design. The design device may precompute the lookup table 220 for this meta atom type 214. A parametrization or function 218 may be chosen for the meta-atom parameters 216, which may be a polynomial function. The desired design order is chosen (typically first order, but it is possible for the desired design order to vary across the meta lens). The coefficients in the parametrization of the meta atom parameters 216 are adjusted or optimized so that the rays behave as desired. For this step, some reasonable guess at pₘᵢₙ and pₘₐₓ is taken but these may not be allowed to vary. The design device 208 may not consider the transmission of the meta atoms and the efficiency of the meta lens at this step. For this step, rays in the design order may be considered.

After a reasonably performant meta lens is achieved, then the design device 208 may re-optimize the meta lens taking both the ray behavior and transmission/efficiency into account. That is, pₘᵢₙ and pₘₐₓ may be allowed to vary and the merit function may include components related to the total energy in the desired design order. At this stage, the merit function can also include components related to the rays in the non-design orders if the user 202 wants to try to optimize where the stray light ends up.

As a last step, other software tools that perform more rigorous electro-magnetic analyses may be used to analyze the meta lens, and/or an optimizer may fine-tune the design, which may include a more rigorous electro-magnetic analysis.

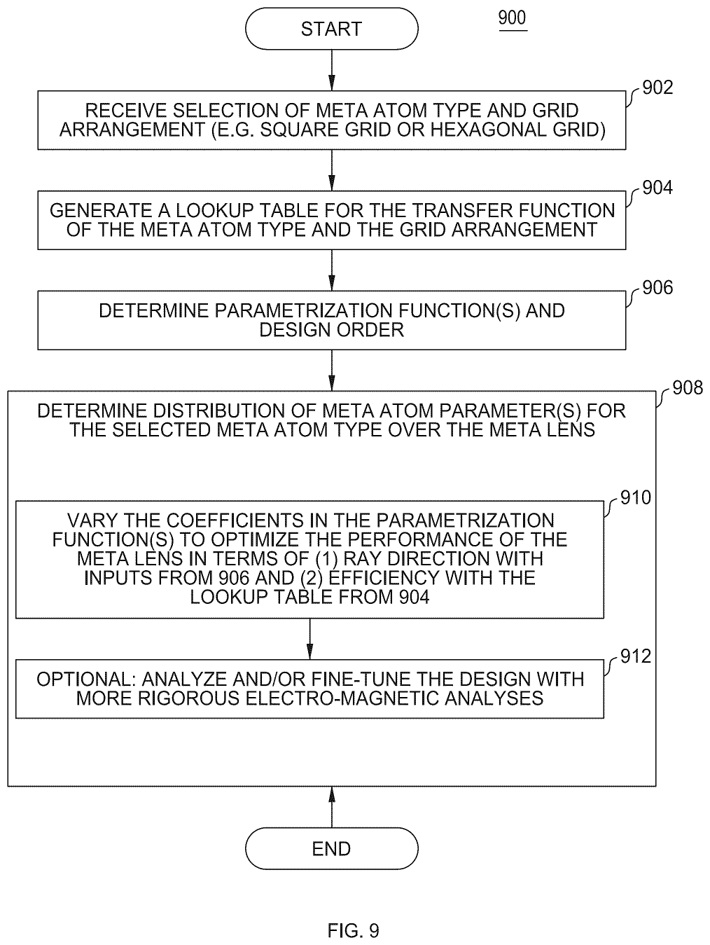

FIG. 9 is a flowchart of an example method 900 to design and analyze a meta lens. In certain embodiments, the design device 208 performs the method 900.

At 902, the design device 208 receives a selection of a meta atom type 214 and a grid arrangement (e.g. square grid or hexagonal grid) for a meta lens. A user 202 may select the meta atom type 214 and the grid arrangement. For example, the user 202 may select a meta atom that is a cylindrical pillar arranged on a square grid.

At 904, the design device 208 generates a lookup table 220 for the transfer function of the meta atom type 214 and the grid arrangement. At 906, the design device 208 receives parametrization function types and design orders. A user 202 of the computer system may select the parametrization function types and the design orders. For example, the user 202 may select a parametrization function type that is polynomial and a design order that equals to one. The design device 208 parametrizes meta atom parameters 216 such that each parameter 216 is expressed as a function 218 of position of a meta atom on the surface of the meta lens.

At 908, the design device 208 determines a layout 222 for the meta lens. The design device 208 may determine a distribution function of meta atom parameters 216 for the selected meta atom type 214 over the meta lens. At 910, to determine the distribution function of the meta atom parameters 216, the design device 208 varies the coefficients in the parametrization functions 218 to optimize or improve the performance of the meta lens in terms of ray direction and efficiency. The design device 208 calculates the ray direction based on inputs from 906 (e.g., the parameterization functions 218). The design device 208 determines the efficiency or the energy based on the lookup table 220 from 904. At 912, which is an optional step, the design device 208 analyzes and/or fine-tunes the meta lens design with more rigorous electro-magnetic analyses.

The design device 208 may determine a direction 224 of a ray exiting the meta lens using the parametrization functions 218 and the design order. In some embodiments, the design device 208 also determines an energy or an efficiency of the ray exiting the meta lens using the lookup table 220.

FIG. 10 illustrates an example machine of a computer system 1000 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 1000 includes a processing device 1002, a main memory 1004 (e.g., read-only memory (ROM), flash memory, dynamic random access memory (DRAM) such as synchronous DRAM (SDRAM), a static memory 1006 (e.g., flash memory, static random access memory (SRAM), etc.), and a data storage device 1018, which communicate with each other via a bus 1030.

Processing device 1002 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 1002 may also be one or more special-purpose processing devices such as an application specific integrated circuit (ASIC), a field programmable gate array (FPGA), a digital signal processor (DSP), network processor, or the like. The processing device 1002 may be configured to execute instructions 1026 for performing the operations and steps described herein.

The computer system 1000 may further include a network interface device 1008 to communicate over the network 1020. The computer system 1000 also may include a video display unit 1010 (e.g., a liquid crystal display (LCD) or a cathode ray tube (CRT)), an alphanumeric input device 1012 (e.g., a keyboard), a cursor control device 1014 (e.g., a mouse), a graphics processing unit 1022, a signal generation device 1016 (e.g., a speaker), graphics processing unit 1022, video processing unit 1028, and audio processing unit 1032.

The data storage device 1018 may include a machine-readable storage medium 1024 (also known as a non-transitory computer-readable medium) on which is stored one or more sets of instructions 1026 or software embodying any one or more of the methodologies or functions described herein. The instructions 1026 may also reside, completely or at least partially, within the main memory 1004 and/or within the processing device 1002 during execution thereof by the computer system 1000, the main memory 1004 and the processing device 1002 also constituting machine-readable storage media.

In some implementations, the instructions 1026 include instructions to implement functionality corresponding to the present disclosure. While the machine-readable storage medium 1024 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 1002 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A method for designing a meta lens, the method comprising:
receiving a selection of a meta atom type;
determining a layout of a plurality of meta atoms of the meta atom type on a meta lens, wherein a first dimension of each meta atom of the plurality of meta atoms is expressed as a first function of a position of the corresponding meta atom on the meta lens; and
determining, based at least in part on the first function, a direction of a ray exiting the meta lens.

2. The method of claim 1, further comprising:
generating a lookup table for a transfer function of the meta atom type for a set of values of the first dimension; and
determining, based at least in part on the lookup table, an efficiency of the ray.

3. The method of claim 2, wherein:
a second dimension of each meta atom of the plurality of meta atoms is expressed as a second function of the position of the corresponding meta atom on the meta lens;
the lookup table indicates the transfer function of the meta atom type for a set of values of the second dimension; and
the direction of the ray exiting the meta lens is based at least in part on the second function.

4. The method of claim 2, wherein generating the lookup table further comprises determining a Jones matrix for the meta atom type for the set of values of the first dimension.

5. The method of claim 4, further comprising determining, based at least in part on the lookup table, a polarization of the ray exiting the meta lens.

6. The method of claim 2, further comprising updating, based at least in part on the layout, the lookup table to have a higher resolution.

7. The method of claim 1, wherein the first function comprises discontinuities along the meta lens.

8. The method of claim 7, wherein the direction of the ray exiting the meta lens is based on positions of the discontinuities along the meta lens.

9. A system for designing a meta lens, the system comprising:
a memory; and
a processor communicatively coupled to the memory, the processor configured to:
receive a selection of a meta atom type;
determine a layout of a plurality of meta atoms of the meta atom type on a meta lens, wherein a first dimension of each meta atom of the plurality of meta atoms is expressed as a first function of a position of the corresponding meta atom on the meta lens; and
determine, based at least in part on the first function, a direction of a ray exiting the meta lens.

10. The system of claim 9, wherein the processor is further configured to:
generate a lookup table for a transfer function of the meta atom type for a set of values of the first dimension; and
determine, based at least in part on the lookup table, an efficiency of the ray.

11. The system of claim 10, wherein:
a second dimension of each meta atom of the plurality of meta atoms is expressed as a second function of the position of the corresponding meta atom on the meta lens;
the lookup table indicates the transfer function of the meta atom type for a set of values of the second dimension; and
the direction of the ray exiting the meta lens is based at least in part on the second function.

12. The system of claim 10, wherein generating the lookup table further comprises determining a Jones matrix for the meta atom type for the set of values of the first dimension.

13. The system of claim 12, wherein the processor is further configured to determine, based at least in part on the lookup table, a polarization of the ray exiting the meta lens.

14. The system of claim 10, wherein the processor is further configured to update, based at least in part on the layout, the lookup table to have a higher resolution.

15. The system of claim 9, wherein the first function comprises discontinuities along the meta lens.

16. The system of claim 15, wherein the direction of the ray exiting the meta lens is based on positions of the discontinuities along the meta lens.

17. A non-transitory computer readable medium storing instructions for designing a meta lens that, when executed by a processor, cause the processor to:
generate a lookup table for a transfer function of a meta atom type;
determine a first function that expresses a first dimension of a plurality of meta atoms of the meta atom type as a function of a position of the plurality of meta atoms on a meta lens; and
determine, based at least in part on the lookup table and the first function, characteristics of a ray exiting the meta lens.

18. The medium of claim 17, wherein the characteristics comprise an energy in the ray exiting the meta lens.

19. The medium of claim 17, wherein the processor further determines a second function that expresses a second dimension of the plurality of meta atoms as a function of the position of the plurality of meta atoms on the meta lens, wherein the characteristics of the ray exiting the meta lens is based at least in part on the second function.

20. The medium of claim 17, wherein the first function comprises discontinuities along the meta lens.
